(19) United States
(12) Patent Application Publication
(10) Pub. No.: US 2010/0171634 A1
(43) Pub. Date: Jul. 8, 2010

(54) Function Configuration Method and Related Device for a Remote Control Device

(76) Inventor: Wei-Kuo Liang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/641,271

(22) Filed: Dec. 17, 2009

(30) Foreign Application Priority Data
Jan. 5, 2009 (TW) 098100099

(51) Int. Cl. G05B 19/02; G06K 9/62; G06F 3/041; G10L 17/00

(52) U.S. Cl. 340/825.22; 382/117; 345/173; 704/246; 382/118; 382/124

(57) ABSTRACT

A function configuration method for a remote control device is disclosed. The remote control device is utilized for controlling an electronic device. The function configuration method includes detecting a touch signal of a user, receiving a human characteristic according to the touch signal, identifying the human characteristic to generate an identification result, and setting functions to be performed by the user in the electronic device.

### BACKGROUND OF THE INVENTION

1. Field of the Invention

The present invention is related to a function configuration method and related device for a remote control device, and more particularly, to a function configuration method and related device capable of providing different control interfaces with respect to different users, to achieve personalized configuration, so as to build an interesting and useful control interface.

2. Description of the Prior Art

With the advancement of electronic technology, various electronic devices have been parts of life in modern society. Also, consumer multimedia products, such as a TV, CD player, DVD player, etc., are widely used in people's daily life recently. In order to facilitate operations of the electronic devices, most of the electronic devices are equipped with remote controllers, such that a user can control an electronic device via a designated remote controller at will.

Using a remote controller to control an electronic device, a user can press a keypad on the remote controller to emit a remote control signal carrying information corresponding to a function of the electronic device. After receiving the remote control signal, the electronic device recognizes information in the remote control signal, and performs the function corresponding to the recognized information. For a long time, the aforementioned operating process is the only remote control method for TVs, audio equipments, DVD players, etc. However, such operation process has no variation, and cannot meet different requirements or achieve personalized configuration. Therefore, the prior art is necessary to be improved.

### SUMMARY OF THE INVENTION

It is therefore a primary objective of the claimed invention to provide a function configuration method and related device for a remote control device.

The present invention discloses a function configuration method for a remote control device utilized for controlling an electronic device. The function configuration method comprises detecting a touch signal of a user, receiving a human characteristic according to the touch signal, identifying the human characteristic of the user, to generate an identification result, and setting functions capable of being performed by the user in the electronic device according to the identification result.

The present invention further discloses a function configuration device for a remote control device for controlling an electronic device. The function configuration device comprises a detecting unit, for detecting a touch signal of a user, a receiving unit, for receiving a human characteristic of the user according to the touch signal, an identifying unit, for identifying the human characteristic, to generate an identification result, and a setting unit, for setting functions capable of being performed by the user in the electronic device according to the identification result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a remote control device according to an embodiment of the present invention.

FIG. 2 is a block diagram of a function configuration device in FIG. 1.

FIG. 3A and FIG. 3B are schematic diagrams of the remote control device in FIG. 1 according to an embodiment of the present invention.

FIG. 4 is a schematic diagram of a function configuration process according to an embodiment of the present invention.

### DETAILED DESCRIPTION

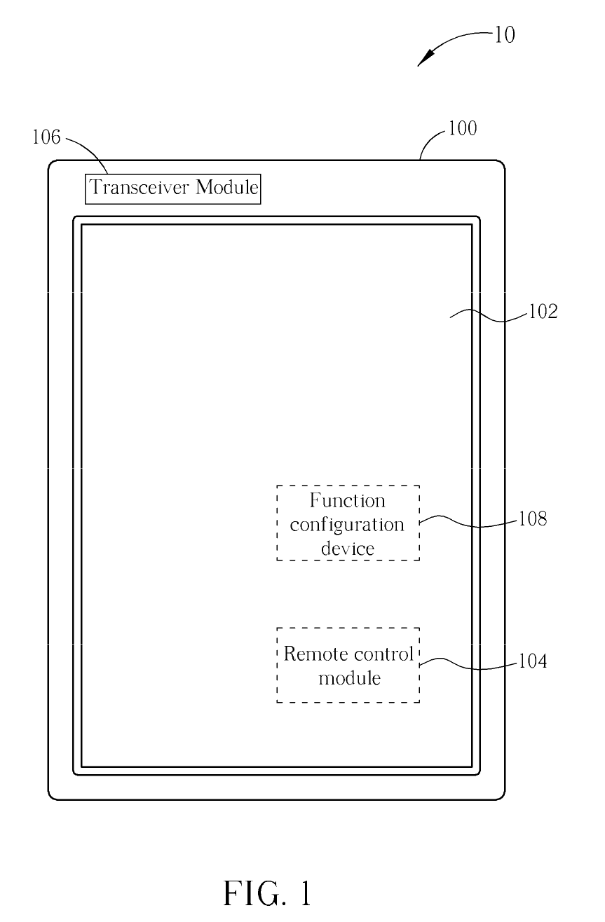

Please refer to FIG. 1, which is a schematic diagram of a remote control device 10 according to an embodiment of the present invention. The remote control device 10 controls an electronic device, which is preferably a TV, an audio equipment or a digital home system, via a wireless communication method, such as infrared ray communication, radio frequency communication, wireless network, etc. The remote control device 10 comprises a case 100, a touch screen 102, a remote control module 104, a transceiver module 106 and a function configuration device 108. The case 100 is utilized for covering inner components of the remote control device 10, to keep the inner components from damages of external force. The touch screen 102 is utilized for displaying a control interface, such as a menu for selecting channels or adjusting volume, so that a user can control the electronic device via the control interface. The remote control module 104 is utilized for translating a control command (e.g. a channel number) provided by the user to suitable control signals, and transmitting the control signals to the electronic device via the transceiver module 106, to control the electronic device. The function configuration device 108 can determine the current user, and adjust functions capable of being performed by the user accordingly.

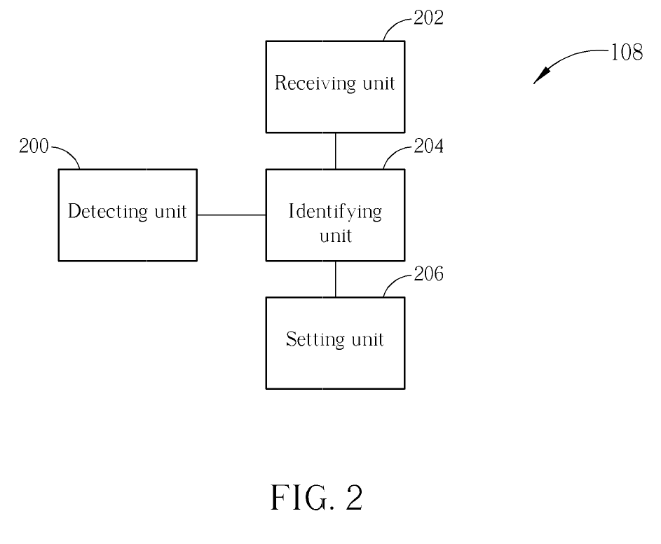

Please continue to refer to FIG. 2, which is a block diagram of the function configuration device 108 in FIG. 1. The function configuration device 108 comprises a detecting unit 200, a receiving unit 202, an identifying unit 204 and a setting unit 206. The detecting unit 200 is installed on the case 100, and utilized for detecting a touch signal of the user, preferably by a thermal sensing method, so as to sense body temperature of the user and determine whether the user picks up or touches the remote control device 10. When the user picks up the remote control device 10, the receiving unit 202 receives a human characteristic of the user, and the identifying unit 204 identifies the human characteristic of the user, to generate an identification result. Finally, the setting unit 206 sets functions capable of being performed by the user in the electronic device according to the identification result. In short, when the detecting unit 200 detects that the user picks up or touches the remote control device 10, the identifying unit 204 recognize the user according to the human characteristic of the user, received by the receiving unit 202, to set the functions capable of being performed by the user via the setting unit 206.

Note that, FIG. 2 is utilized for illustrating basic functions of the function configuration device 108. Actually, those skilled in the art can modify the function configuration device 108 accordingly. For example, the receiving unit 202 is not limited to any device or component, and is acceptable if the receiving unit 202 can co-work with the identifying unit 204. For instance, if the identifying unit 204 can identify a face characteristic of the user, the receiving unit 202 should be an image receiver (e.g. video camera, digital camera). If the identifying unit 204 can identify an iris characteristic of the user, the receiving unit 202 should be an iris scanner. If the identifying unit 204 can identify a fingerprint characteristic of the user, the receiving unit 202 should be a fingerprint receiver. If the identifying unit 204 can identify a voiceprint characteristic of the user, the receiving unit 202 should be a microphone.

In addition, the function configuration device 108 preferably includes an information storage device (not shown in FIG. 2), for pre-storing information of functions capable of being performed by different users, so that the setting unit 206 can complete the setting operation. Moreover, the touch screen 102 implements a display unit, to display related control interface. Furthermore, the function configuration device 108 can include an adjusting unit, utilized for adjusting attributes of the control interface, such as a size, a color, etc., according to the identification result of the identifying unit 204. In such a situation, except setting functions capable of being performed by different users, the function configuration device 108 can provide personalized configuration. For example, if the remote control device 10 is utilized for controlling a TV, the user can set control interfaces corresponding to family members. For example, when a minor child picks up the remote control device 10, the function configuration device 108 only allows the minor child to select G (General Audiences) class channels. When an elder family member picks up the remote control device 10, the function configuration device 108 can automatically magnify the menu of the control interface. Certainly, the user can set other functions or attributes, and is not limited in these two examples.

Note that, the present invention uses the function configuration device 108 to determine information of the user, and accordingly set functions capable of being performed by the user. In such situation, the present invention can provide a personalized operating environment, and meanwhile, ensure the minor child can only select the G class channels. In addition, those skilled in the art can further add functions to the function configuration device 108. For example, the function configuration device 108 can preferably include a message storage unit and a message indication unit (not shown in FIG. 2), utilized for implementing a guest book. The message storage unit is utilized for pre-storing messages corresponding to the user, such as a text file, an image file, an audio file, etc. The message indication unit is utilized for outputting the messages corresponding to the user via the electronic device according to the identification result of the identifying unit 204. As a result, when the user picks up the remote control device 10, the function configuration device 108 can identify the user, and accordingly output the messages corresponding to the user via the electronic device, such that the user can be aware of the messages, images or voices, etc., from other people.

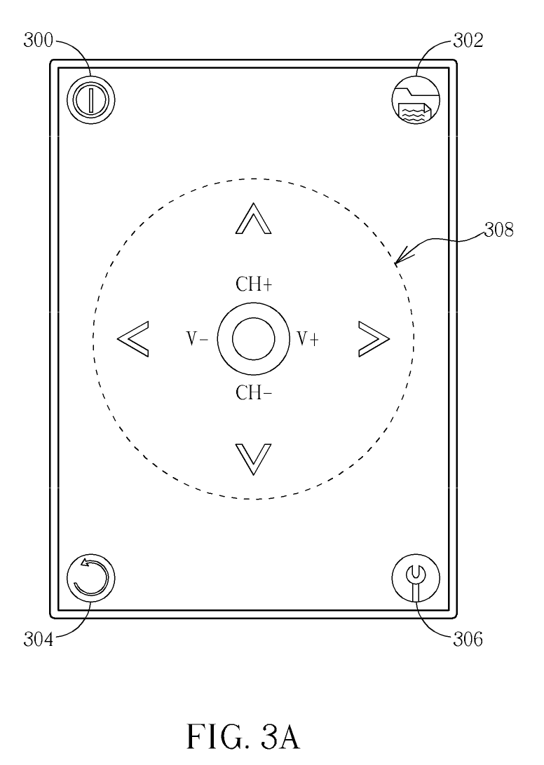

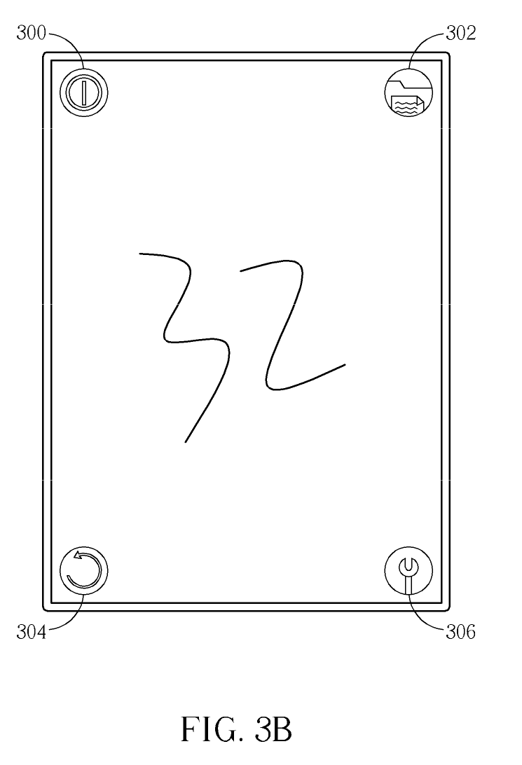

As mentioned above, the inventive concept of the present invention is to identify the user, and accordingly set functions capable of being performed by users via the function configuration device 108. Certainly, other functions can be added to the function configuration device 108 according to different requirements. For example, in FIG. 3A, the electronic device is a TV, and the touch screen 102 displays menus 300, 302, 304, 306 and 308. The menu 300 is utilized for controlling power of the electronic device. The menu 302 is utilized for displaying a program list. The menu 304 is utilized for controlling to return to a previous channel. The menu 306 is utilized for adjusting various configurations. The menu 308 is utilized for controlling switching of channels and volume levels. The user can switch channels by pressing keypads CH+ and CH− in the menu 308. Or, the user can double click the touch screen 102, to input a channel number by handwriting, so as to switch to the channel, as shown in FIG. 3B.

Therefore, via the present invention, when the user picks up the remote control device 10, the function configuration device 108 can identify the user, and accordingly set functions capable of being performed by the user, or initiate the personalized control interface, to provide various operating processes. In addition, the present invention can further include other functions, such as the guest book, to build an interesting and useful control interface.

In the prior art, keypads of a remote control device are corresponding to fixed functions, such that the remote control device cannot provide variations or achieve personalized configuration. In comparison, in the present invention, the remote control device 10 can provide different control interfaces with respect to different users, so as to achieve the personalized configuration.

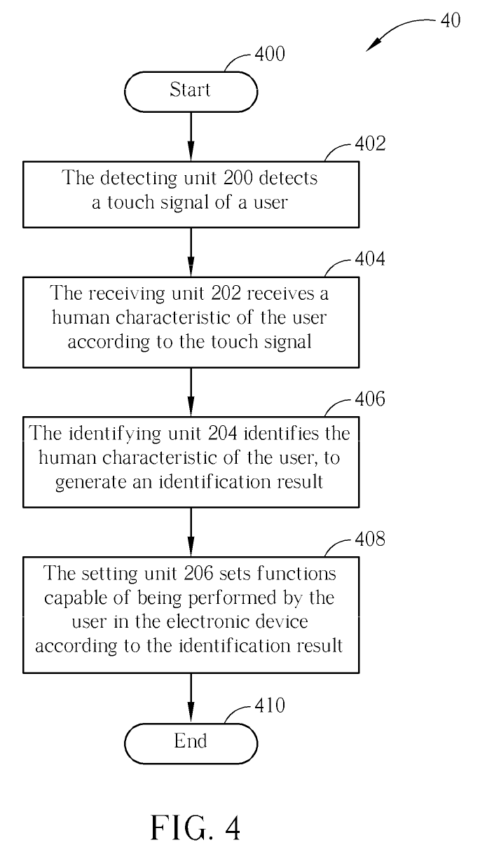

Operations of the function configuration device 108 can further be summarized to a function configuration process 40, as illustrated in FIG. 4. The function configuration process 40 comprises the following steps:

Step 400: Start.

Step 402: The detecting unit 200 detects a touch signal of a user.

Step 404: The receiving unit 202 receives a human characteristic of the user according to the touch signal.

Step 406: The identifying unit 204 identifies the human characteristic of the user, to generate an identification result.

Step 408: The setting unit 206 sets functions capable of being performed by the user in the electronic device according to the identification result.

Step 410: End.

The function configuration process 40 is utilized for illustrating the operations of the function configuration device 108, and detailed description can be referred in the above and not given herein for brevity.

To sum up, the present invention can identify the human characteristic of the user, to determine the user, so as to set functions capable of being performed by the user in the electronic device. As a result, the present invention can provide different control interfaces with respect to different users, to achieve personalized configuration, and build an interesting and useful control interface.

Those skilled in the art will readily observe that numerous modifications and alterations of the device and method may be made while retaining the teachings of the invention.

What is claimed is:

1. A function configuration method for a remote control device utilized for controlling an electronic device, the function configuration method comprising:
detecting a touch signal of a user;
receiving a human characteristic according to the touch signal;
identifying the human characteristic of the user, to generate an identification result; and
setting functions capable of being performed by the user in the electronic device according to the identification result.

2. The function configuration method of claim 1, wherein detecting the touch signal of the user is detecting the touch signal of the user by a thermal sensing method.

3. The function configuration method of claim 1, wherein the human characteristic is a face characteristic of the user.

4. The function configuration method of claim 1, wherein the human characteristic is an iris characteristic of the user.

5. The function configuration method of claim 1, wherein the human characteristic is a fingerprint characteristic of the user.

6. The function configuration method of claim 1, wherein the human characteristic is a voiceprint characteristic of the user.

7. The function configuration method of claim 1 further comprising:
pre-storing information of the functions capable of being performed by the user in the electronic device; and
displaying a control interface according to the functions capable of being performed by the user in the electronic device.

8. The function configuration method of claim 7 further comprising adjusting an attribute of the control interface according to the identification result, wherein the attribute is a size of the control interface or a color of the control interface.

9. The function configuration method of claim 1 further comprising outputting a message corresponding to the user via the electronic device according to the identification result, wherein the message is a text file, an image file, or an audio file.

10. The function configuration method of claim 9 further comprising pre-storing the message corresponding to the user.

11. The function configuration method of claim 1, wherein the electronic device is a television, and the functions capable of being performed by the user in the electronic device is channels to be selected by the user.

12. A function configuration device for a remote control device for controlling an electronic device, the function configuration device comprising:
a detecting unit, for detecting a touch signal of a user;
a receiving unit, for receiving a human characteristic of the user according to the touch signal;
an identifying unit, for identifying the human characteristic, to generate an identification result; and
a setting unit, for setting functions capable of being performed by the user in the electronic device according to the identification result.

13. The function configuration device of claim 12, wherein the detecting unit detects the touch signal of the user by a thermal sensing method.

14. The function configuration device of claim 12, wherein the receiving unit is an image receiver, and the human characteristic is a face characteristic of the user.

15. The function configuration device of claim 12, wherein the receiving unit is an iris scanner, and the human characteristic is an iris characteristic of the user.

16. The function configuration device of claim 12, wherein the receiving unit is a fingerprint receiver, and the human characteristic is a fingerprint characteristic of the user.

17. The function configuration device of claim 12, wherein the receiving unit is a microphone, and the human characteristic is a voiceprint characteristic of the user.

18. The function configuration device of claim 12 further comprising:
an information storage device, for pre-storing information of the functions capable of being performed by the user in the electronic device; and
a display unit, for displaying a control interface according to the functions capable of being performed by the user in the electronic device.

19. The function configuration device of claim 18, wherein the display unit is a touch screen, and the control interface is a menu displayed on the touch screen.

20. The function configuration device of claim 18 further comprising an adjusting unit, for adjusting an attribute of the control interface according to the identification result, wherein the attribute is a size of the control interface or a color of the control interface.

21. The function configuration device of claim 12 further comprising a message indication unit, for outputting a message corresponding to the user via the electronic device according to the identification result, wherein the message is a text file, an image file, or an audio file.

22. The function configuration device of claim 21 further comprising a message storage unit, for pre-storing the message corresponding to the user.

23. The function configuration device of claim 12, wherein the electronic device is a television, and the functions capable of being performed by the user in the electronic device is channels capable of being selected by the user.
